(19) United States
(12) Patent Application Publication
(10) Pub. No.: US 2022/0174302 A1
(43) Pub. Date: Jun. 2, 2022

(54) IMAGE DECODING DEVICE, IMAGE DECODING METHOD, AND PROGRAM

(71) Applicant: KDDI CORPORATION, Tokyo (JP)

(72) Inventors: Kei KAWAMURA, Saitama (JP); Sei NAITO, Saitama (JP)

(73) Assignee: KDDI CORPORATION, Tokyo (JP)

(21) Appl. No.: 17/675,500

(22) Filed: Feb. 18, 2022

Related U.S. Application Data
(63) Continuation of application No. PCT/JP2020/043745, filed on Nov. 25, 2020.

(30) Foreign Application Priority Data
Dec. 26, 2019 (JP) 2019-237290

(51) Int. Cl. H04N 19/44; H04N 19/186; H04N 19/46

(52) U.S. Cl. CPC H04N 19/44; H04N 19/46; H04N 19/186

(57) ABSTRACT

An image decoding device includes: a chroma quantization parameter offset initialization unit configured to initialize a chroma offset based on a result of decoding coded data; a chroma offset deriving unit configured to set and derive the chroma offset based on the result of decoding the coded data; a chroma deriving unit configured to derive a chroma based on the chroma offset derived by the chroma offset deriving unit; and a coding unit level chroma QP initialization unit configured to initialize the chroma QP offset for each coding unit that is not recursively partitioned.

### CROSS-REFERENCE TO RELATED APPLICATIONS

The present application is a continuation based on PCT Application No. PCT/JP2020/043745, filed on Nov. 25, 2020, which claims the benefit of Japanese patent application No. 2019-237290, filed on Dec. 26, 2019. The content of both of which are incorporated by reference herein in their entirety.

### TECHNICAL FIELD

The present invention relates to an image decoding device, an image decoding method, and a program.

### BACKGROUND

Conventionally, an image coding method using intra prediction or inter prediction, transform/quantization of a prediction residual signal, and entropy coding has been proposed (see, for example, ITU-T H.265 High Efficiency Video Coding).

Hereinafter, a coding unit division method in Versatile Video Coding (VVC) Draft 7, which is a next-generation video coding method, and a chrominance intra prediction method in intra prediction will be described (see Versatile Video Coding (Draft 7)).

As illustrated in FIG. 8, coding units in both methods are recursively partitioned by using a quad tree, a binary tree, and a ternary tree. Here, the same division pattern may be selected (single tree) or different division patterns may be selected (dual tree) between a luminance component and a chrominance component.

Versatile Video Coding (Draft 7) discloses a method for controlling a quantization parameter (QP) value of a chrominance block. The QP value of the chrominance block is derived by converting the QP value of the corresponding luminance block by using a correspondence table and adding an offset designated by an upper granularity represented by a picture, a slice, or a coding block. Further, the derived QP value of the chrominance block is used to determine a deblocking filter.

### SUMMARY

However, the VVC Draft 7, which is a next-generation video coding method, has a problem that the QP value of the chrominance block is used in deblocking filter processing in the chrominance block, and such a QP value does not exist when there is no prediction residual signal.

Therefore, the present invention has been made in view of the above-described problems, and an object of the present invention is to provide an image decoding device, an image decoding method, and a program capable of improving deblocking filter performance for a block in which a coefficient is not coded, in determining a deblocking filter for a chrominance block.

Another object of the present invention is to provide an image decoding device, an image decoding method, and a program capable of improving deblocking filter performance for a block in which a coefficient is not coded and an immediately previous block in a decoding order since consistency is maintained in determining a deblocking filter for an adjacent chrominance block.

Another object of the present invention is to provide an image decoding device, an image decoding method, and a program capable of improving parallel processing functionality of a deblocking filter because parallelism is maintained in determining a deblocking filter for different chrominance blocks in parallel processing units.

The first aspect of the present invention is summarized as an image decoding device configured to decode coded data, the image decoding device including: a chroma quantization parameter (QP) offset initialization unit configured to initialize a chroma QP offset based on a result of decoding the coded data; a chroma QP offset deriving unit configured to set and derive the chroma QP offset based on the result of decoding the coded data; a chroma QP deriving unit configured to derive a chroma QP based on the chroma QP offset derived by the chroma QP offset deriving unit; and a coding unit level chroma QP initialization unit configured to initialize the chroma QP offset for each coding unit that is not recursively partitioned.

The second aspect of the present invention is summarized as an image decoding method including: initializing a chroma QP offset based on a result of decoding coded data; setting and deriving the chroma QP offset based on the result of decoding the coded data; deriving a chroma QP based on the derived chroma QP offset; and initializing the chroma QP offset for each coding unit that is not recursively partitioned.

The third aspect of the present invention is summarized as a program that causes a computer to function as an image decoding device configured to decode coded data, the image decoding device including: a chroma QP offset initialization unit configured to initialize a chroma QP offset based on a result of decoding the coded data; a chroma QP offset deriving unit configured to set and derive the chroma QP offset based on the result of decoding the coded data; a chroma QP deriving unit configured to derive a chroma QP based on the chroma QP offset derived by the chroma QP offset deriving unit; and a coding unit level chroma QP initialization unit configured to initialize the chroma QP offset for each coding unit that is not recursively partitioned.

According to the present invention, it is possible to provide an image decoding device, an image decoding method, and a program capable of improving deblocking filter performance for a block in which a coefficient is not coded, in determining a deblocking filter for a chrominance block.

Furthermore, according to the present invention, it is possible to provide an image decoding device, an image decoding method, and a program capable of improving deblocking filter performance for a block in which a coefficient is not coded and an immediately previous block in a decoding order since consistency is maintained in determining a deblocking filter for an adjacent chrominance block.

Furthermore, according to the present invention, it is possible to provide an image decoding device, an image decoding method, and a program capable of improving parallel processing functionality of a deblocking filter because parallelism is maintained in determining a deblocking filter for different chrominance blocks in parallel processing units.

### BRIEF DESCRIPTION OF DRAWINGS

FIG. 1 is a diagram illustrating an example of a configuration of an image processing system 1 according to an embodiment.

FIG. 2 is a diagram illustrating an example of functional blocks of an image coding device 100 according to the embodiment.

FIG. 3 is a diagram illustrating an example of some functional blocks of an entropy coding unit 104 of the image coding device 100 and an entropy decoding unit 201 of an image decoding device 200 according to the embodiment.

FIG. 4 is a diagram illustrating an example of syntax indicating processing in a chroma QP offset initialization unit 104A of the entropy coding unit 104 of the image coding device 100 according to the embodiment.

FIG. 5 is a diagram illustrating an example of functional blocks of the image decoding device 200 according to the embodiment.

FIG. 6 is a flowchart illustrating an example of an operation of the entropy decoding unit 201 of the image decoding device 200 according to the embodiment.

FIG. 7 is a diagram illustrating an example of some functional blocks of an entropy coding unit 104 of an image coding device 100 and an entropy decoding unit 201 of an image decoding device 200 according to an embodiment.

FIG. 8 is a diagram for describing a conventional technique.

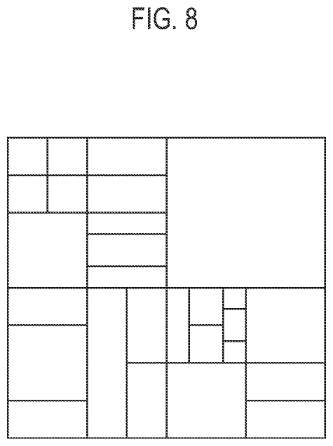

### DETAILED DESCRIPTION

Hereinafter, embodiments of the present invention will be described with reference to the drawings. Note that components in the following embodiments can be replaced with existing components or the like as appropriate, and various variations including combinations with other existing components are possible. Therefore, the following description of the embodiments does not limit the contents of the invention described in the claims.

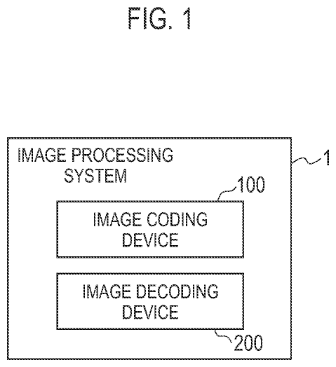

FIG. 1 is a diagram illustrating an example of functional blocks of an image processing system 1 according to a first embodiment of the present invention. The image processing system 1 includes an image coding device 100 that codes a video to generate coded data, and an image decoding device 200 that decodes the coded data generated by the image coding device 100. The above-described coded data is transmitted and received between the image coding device 100 and the image decoding device 200 via a transmission path, for example.

### <Image Coding Device 100>

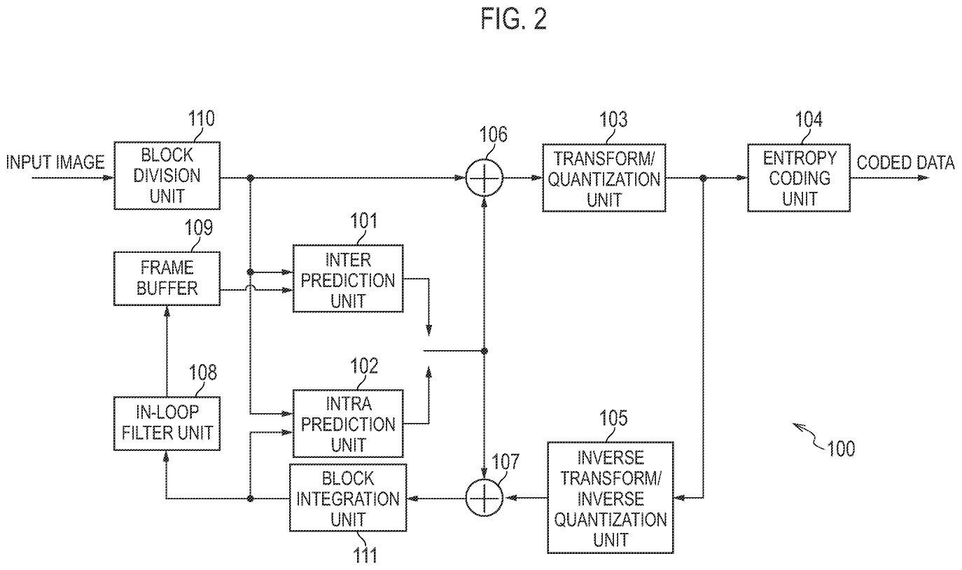

FIG. 2 is a diagram illustrating an example of functional blocks of the image coding device 100. As illustrated in FIG. 2, the image coding device 100 includes an inter-prediction unit 101, an intra-prediction unit 102, a transform/quantization unit 103, an entropy coding unit 104, an inverse transform/inverse quantization unit 105, a subtracting unit 106, an adding unit 107, an in-loop filter unit 108, a frame buffer 109, a block division unit 110, and a block integration unit 111.

The block division unit 110 is configured to divide an entire screen of an input image into the same squares, and output an image (divided image) obtained by recursive division using a quad tree or the like.

The inter-prediction unit 101 is configured to perform inter-prediction by using the divided image input by the block division unit 110 and a locally decoded image after filtering input from the frame buffer 109 to generate and output an inter-prediction image.

The intra-prediction unit 102 is configured to perform intra-prediction by using the divided image input by the block division unit 110 and a locally decoded image before filtering (described later) to generate and output an intra-prediction image.

The transform/quantization unit 103 is configured to execute orthogonal transform processing on a residual signal input from the subtracting unit 106, execute quantization processing on a transform coefficient obtained by the orthogonal transform processing, and output a quantized level value obtained by the quantization processing.

The entropy coding unit 104 is configured to perform entropy coding on the quantized level value, transform unit size, and transform size input from the transform/quantization unit 103 and output coded data.

The inverse transform/inverse quantization unit 105 is configured to execute inverse quantization processing on the quantized level value input from the transform/quantization unit 103, execute inverse orthogonal transform processing on a transform coefficient obtained by the inverse quantization processing, and output an inversely orthogonally transformed residual signal obtained by the inverse orthogonal transform processing.

The subtracting unit 106 is configured to output the residual signal that is a difference between the divided image input by the block division unit 110 and the intra-prediction image or the inter-prediction image.

The adding unit 107 is configured to output a divided image obtained by adding the inversely orthogonally transformed residual signal input from the inverse transform/inverse quantization unit 105 and the intra-prediction image or the inter-prediction image.

The block integration unit 111 is configured to output the locally decoded image before filtering obtained by integrating the divided images input from the adding unit 107.

The in-loop filter unit 108 is configured to apply in-loop filtering processing such as deblocking filter processing to the locally decoded image before filtering input from the block integration unit 111 to generate and output the locally decoded image after filtering. Here, the locally decoded image before filtering is a signal obtained by adding the residual signal subjected to the inverse orthogonal transform and the intra-prediction image or the inter-prediction image.

The frame buffer 109 accumulates the locally decoded image after filtering and appropriately supplies the locally decoded image after filtering to the inter-prediction unit 101 as the locally decoded image after filtering.

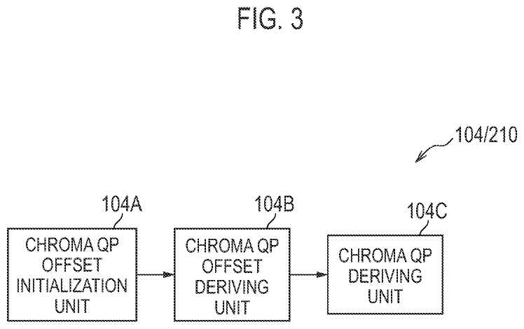

Hereinafter, the entropy coding unit 104 of the image coding device 100 according to the present embodiment will be described with reference to FIG. 3. FIG. 3 is a diagram illustrating an example of some functional blocks of the entropy coding unit 104 of the image coding device 100 according to the present embodiment.

As illustrated in FIG. 3, the entropy coding unit 104 of the image coding device 100 according to the present embodiment includes a chroma quantization parameter (QP) offset initialization unit 104A, a chroma QP offset deriving unit 104B, and a chroma QP deriving unit 104C.

The chroma QP offset initialization unit 104A is configured to receive a valid flag of an offset value and chroma QP division granularity.

Here, the chroma QP offset initialization unit 104A is configured to initialize a chroma QP offset based on the valid flag of the offset value and the input chroma QP division granularity that are input.

Specifically, the chroma QP offset initialization unit 104A is configured to reset (set to “0”) and output the chroma QP offset in a case where the valid flag of the offset value is valid and the chroma QP division granularity is equal to or less than a predetermined value.

On the other hand, the chroma QP offset initialization unit 104A is configured to maintain and output the current chroma QP offset in a case where the valid flag of the offset value is not valid or in a case where the chroma QP division granularity is not equal to or less than the predetermined value.

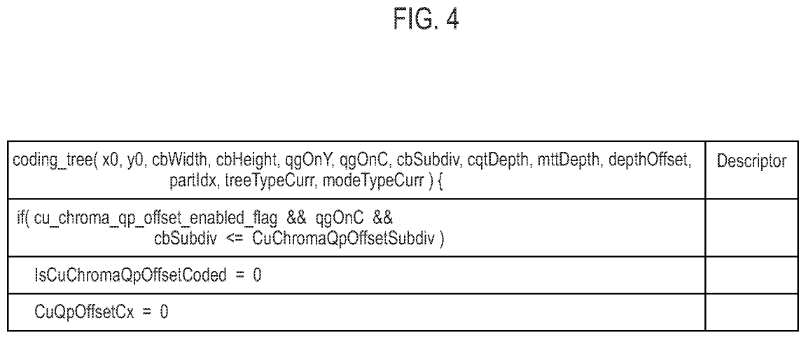

FIG. 4 illustrates syntax representing processing in the chroma QP offset initialization unit 104A.

Here, “cu_chroma_qp_offset_enabled_flag” indicates the above-described valid flag of the offset value, “qgOnC” indicates a valid flag of a control unit of quantization of a chrominance block, “cbSubdiv” indicates the above-described chroma QP division granularity, and “CuChromaQpOffsetSubdiv” indicates the above-described predetermined value.

“IsCuChromaQpOffsetCoded” indicates a flag indicating whether or not the chroma QP offset value is coded for a coding unit, and “CuChromaQpOffsetIdx” indicates the above-described chroma QP offset.

Note that, instead of CuChromaQpOffsetIdx, syntax corresponding to a chrominance coding method such as CuQpOffsetCb, CuQpOffsetCr, or CuQpOffsetCbCr may be used.

The chroma QP offset deriving unit 104B is configured to receive a chroma QP offset flag and a chroma QP offset index derived by a control unit (not illustrated) and the chroma QP offset initialized by the chroma QP offset initialization unit 104A.

Here, the chroma QP offset deriving unit 104B is configured to set and derive the chroma QP offset based on the input chroma QP offset flag, chroma QP offset index, and chroma QP offset.

Specifically, the chroma QP offset deriving unit 104B is configured to output a zero value as the derived chroma QP offset when the chroma QP offset flag is invalid.

On the other hand, the chroma QP offset deriving unit 104B is configured to output a value obtained by converting the chroma QP offset index by applying a chroma QP offset list, as the derived chroma QP offset when the chroma QP offset flag is valid.

The following (Equation 1) illustrates an example of processing in the chroma QP offset deriving unit 104B in a case where the chroma QP offset flag is valid.

CuQpOffsetCx=cx_qp_offset_list[CuChromaQpOffsetIdx] (Equation 1)

Note that Cx in the equation may be individually defined as Cb, Cr, or CbCr.

Here, “cx_qp_offset_list[ ]” indicates the chroma QP offset list.

The chroma QP deriving unit 104C is configured to receive a luma QP and the chroma QP offset.

Further, the chroma QP deriving unit 104C is configured to derive and output a chroma QP based on the input luma QP and chroma QP offset.

Specifically, the chroma QP deriving unit 104C is configured to derive the chroma QP by adding the chroma QP offset to a value obtained by converting the luma QP by applying a conversion table.

For example, the following (Equation 2) to (Equation 4) show an example of processing in the chroma QP deriving unit 104C.

qP_{Chroma}=Clip3(−QpBdOffset,63,Qp_{y}) (Equation 2)

qP_{Cx}=ChromaQpTable[i][qP_{Chroma}] (Equation 3)

Qp′_{cx}=Clip3(−QpBdOffset,63,Qp_{Cx}+pps_cx_qp_offset+slice_cx_qp_offset+CuQpOffsetCx)+QpBdOffset (Equation 4)

Note that Cx in the equation may be individually defined as Cb, Cr, or CbCr.

Here, “QpBdOffset” indicates an offset of a quantization parameter range, “Qp_{y}” indicates the luma QP before applying the offset of the quantization parameter range, “ChromaQpTable” indicates a table for conversion from the luma QP according to the chrominance coding method to the chroma quantization parameter, “i” indicates the type of the chrominance coding method, “pps_cx_qp_offset” indicates an offset from the luma QP of each picture to the chroma quantization parameter, and “slice_cx_qp_offset” indicates a value added to pps_cx_qp_offset of each slice.

### <Image Decoding Device 200>

The entropy decoding unit 201 is configured to perform entropy decoding on the coded data and output the quantized level value, a motion compensation method generated by the image coding device 100, and the like.

The inverse transform/inverse quantization unit 202 is configured to execute inverse quantization processing on the quantized level value input from the entropy decoding unit 201, execute inverse orthogonal transform processing on a result obtained by performing the inverse quantization processing, and output the result as the residual signal.

The inter-prediction unit 203 is configured to perform inter-prediction by using a locally decoded image after filtering input from the frame buffer 207 to generate and output an inter-prediction image.

The intra-prediction unit 204 is configured to perform intra-prediction by using a locally decoded image before filtering input from the adding unit 205 to generate and output an intra predicted image.

The adding unit 205 is configured to output a divided image obtained by adding the residual signal input from the inverse transform/inverse quantization unit 202 and the prediction image (the inter-prediction image input from the inter-prediction unit 203 or the intra-prediction image input from the intra-prediction unit 204).

Here, the prediction image is a prediction image calculated by a prediction method obtained by entropy decoding among the inter-prediction image input from the inter-prediction unit 203 and the intra-prediction image input from the intra-prediction unit 204.

The block integration unit 208 is configured to output the locally decoded image before filtering obtained by integrating the divided images input from the adding unit 205.

The in-loop filter unit 206 is configured to apply in-loop filtering processing such as deblocking filtering processing to the locally decoded image before filtering input from the block integration unit 208 to generate and output the locally decoded image after filtering.

The frame buffer 207 is configured to accumulate the locally decoded image after filtering input from the in-loop filter 206, appropriately supply the locally decoded image after filtering to the inter-prediction unit 203 as the locally decoded image after filtering, and output the locally decoded image after filtering as a decoded image.

Hereinafter, the entropy decoding unit 201 of the image decoding device 200 according to the present embodiment will be described with reference to FIG. 3.

Specifically, similarly to the entropy coding unit 104 of the image coding device 100 illustrated in FIG. 3, the entropy decoding unit 201 includes a chroma QP offset initialization unit 104A, a chroma QP offset deriving unit 104B, and a chroma QP deriving unit 104C.

Here, the chroma QP offset initialization unit 104A is configured to initialize the chroma QP offset based on a result of decoding the coded data.

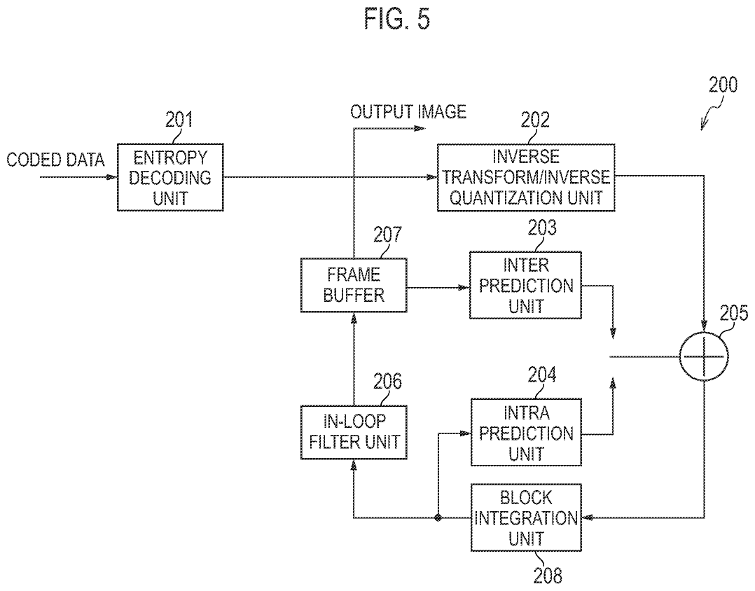

Hereinafter, an example of an operation of the entropy decoding unit 201 according to the present embodiment will be described with reference to FIG. 5.

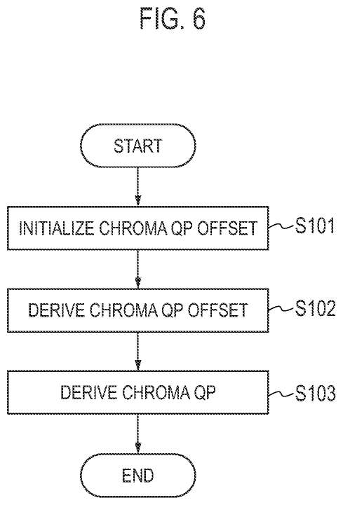

As illustrated in FIG. 6, in Step S101, the entropy decoding unit 201 initializes the chroma QP offset based on the result of decoding the coded data transmitted from the image coding device 100.

Specifically, the entropy decoding unit 201 is configured to initialize the chroma QP offset based on the valid flag of the offset value and the chroma QP division granularity that are input.

In Step S102, the entropy decoding unit 201 sets and derives the chroma QP offset based on the result of decoding the coded data.

Specifically, the entropy decoding unit 201 sets and derives the chroma QP offset based on the chroma QP offset flag and the chroma QP offset index which are the result of decoding the coded data and the initialized chroma QP offset.

In Step S103, the entropy decoding unit 201 derives the chroma QP based on the derived chroma QP offset.

Specifically, the entropy decoding unit 201 derives and outputs the chroma QP based on the luma QP (not illustrated) and the derived chroma QP offset.

With the image processing system 1 according to the present embodiment, in the determination of the deblocking filter for the chrominance block, the deblocking filter performance for the block in which the coefficient is not coded can be improved.

Specifically, the QP value is required to determine the deblocking filter, but in the VVC Draft 7, there is a case where the QP offset of the block with no coefficient is not defined, the QP value becomes undefined, and the deblocking filter cannot be determined. Alternatively, in the VVC Draft 7, in a case where the QP offset of the block with no coefficient is not defined, when the QP value that seems to be appropriate is derived, the determination of the deblocking filter becomes inaccurate, and the performance is degraded.

Therefore, the image processing system 1 according to the present embodiment generally improves the determination of deblocking, and as a result, the performance can be improved.

Hereinafter, an image processing system 1 according to a second embodiment of the present invention will be described focusing on differences from the image processing system 1 according to the first embodiment described above.

In the present embodiment, a chroma QP offset initialization unit 104A is configured to set the chroma QP offset set in the immediately previous chrominance block in the decoding order in the initialization of the chroma QP offset in a case where the valid flag of the offset value is valid and the chroma QP division granularity is equal to or less than the predetermined value.

With the image processing system 2 according to the present embodiment, in the determination of the deblocking filter for the chrominance block, it is possible to improve the deblocking filter performance for the block in which the coefficient is not coded and the immediately previous block in the decoding order.

### Third Embodiment

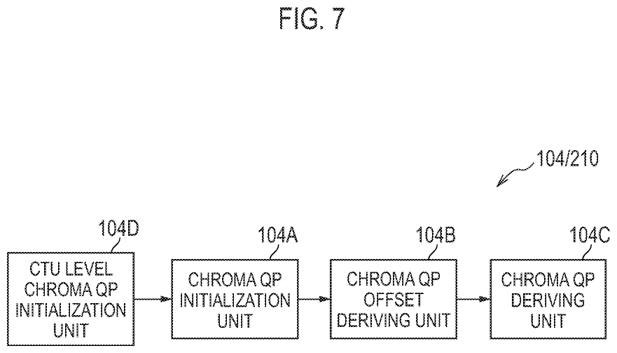

Hereinafter, an image processing system 1 according to a third embodiment of the present invention will be described focusing on differences from the above-described image processing system 1 according to the first embodiment with reference to FIG. 7.

As illustrated in FIG. 7, in the present embodiment, the entropy coding unit 104 of the image coding device 100 and the entropy decoding unit 201 of the image decoding device 200 include a CTU level chroma QP initialization unit 104D in addition to the configuration illustrated in FIG. 3.

The CTU level chroma QP initialization unit 104D and the chroma QP offset initialization unit 104A have different granularity in initializing the chroma QP offset.

The CTU level chroma QP initialization unit 104D is configured to initialize the chroma QP offset for each CTU (that is, a coding unit that is not recursively partitioned).

Specifically, the CTU level chroma QP initialization unit 104D is configured to reset and output the chroma QP offset for each CTU regardless of the input in the initialization for each CTU.

Here, a CTU level may be a unit serving as a start point of recursive partition.

Note that the CTU level chroma QP initialization unit 104D may be configured to initialize the chroma QP offset not for each CTU but for each CTU line, for each title, for each slice, or for each picture.

In a case of initializing the chroma QP offset for each CTU line, the CTU level chroma QP initialization unit 104D may associate the chroma QP offset with an entropy coding synchronization enabling flag (entropy coding sync flag).

With the image processing system 3 according to the present embodiment, the parallel processing functionality of the deblocking filter can be improved in the determination of the deblocking filter for the different chrominance blocks in parallel processing units.

The image coding device 100 and the image decoding device 200 described above may be implemented as programs that cause a computer to execute respective functions (respective steps).

Note that the above described embodiments have been described by taking application of the present invention to the image encoding device 10 and the image decoding device 30 as examples. However, the present invention is not limited only thereto, but can be similarly applied to an encoding/decoding system having functions of the image encoding device 10 and the image decoding device 30.

What is claimed is:

1. An image decoding device configured to decode coded data, the image decoding device comprising a circuit, wherein
the circuit:
initializes a chroma QP (quantization parameter) offset based on a result of decoding the coded data;
sets and derives the chroma QP offset based on the result of decoding the coded data;
derives a chroma QP based on the chroma QP offset derived by the chroma QP offset deriving unit; and
initializes the chroma QP offset for each coding unit that is not recursively partitioned.

2. An image decoding method comprising:
initializing a chroma QP offset based on a result of decoding coded data;
setting and deriving the chroma QP offset based on the result of decoding the coded data;
deriving a chroma QP based on the derived chroma QP offset; and
initializing the chroma QP offset for each coding unit that is not recursively partitioned.

3. A program stored on a non-transitory computer-readable medium that causes a computer to function as an image decoding device decodes coded data, the image decoding device including a circuit, wherein:
the circuit:
initializes a chroma QP offset based on a result of decoding the coded data;
sets and derives the chroma QP offset based on the result of decoding the coded data;
derives a chroma QP based on the chroma QP offset derived by the chroma QP offset deriving unit; and
initializes the chroma QP offset for each coding unit that is not recursively partitioned.
